(19) United States
(12) Patent Application Publication
(10) Pub. No.: US 2011/0272847 A1
(43) Pub. Date: Nov. 10, 2011

(54) DEVICE AND METHOD FOR PRODUCING MOLDED PARTS FROM PLASTICISABLE MATERIAL AND FROM FIBROUS INSERTS

(75) Inventor: Karl Hehl, Lossburg (DE)

(73) Assignee: Renate KEINATH, Balingen (DE)

(21) Appl. No.: 13/132,696

(22) PCT Filed: Dec. 8, 2009
(86) PCT No.: PCT/EP2009/008732

§ 371 Date: Jul. 19, 2011

(30) Foreign Application Priority Data
Dec. 10, 2008 (DE) 10 2008 061 270 7

(51) Int. Cl. B29C 45/18

(52) U.S. Cl. 264/163; 425/587

(57) ABSTRACT

The invention relates to a device for producing molded parts from plasticizable material and from fibrous inserts on a cyclically operating injection molding machine for processing plastics, comprising a plasticization unit (10) and a plasticization worm (11) disposed therein. In order to feed in the fibrous inserts, at least one insertion opening (14) is provided on the plasticization unit (10) for the plasticizable material downstream of the material infeed area (13) in the feed direction of the plasticization worm (11). Targeted insertion in the cycle of the injection molding machine is made possible by a device (18) operating in the cycle of the injection molding machine for inserting the fibrous inserts into the plasticizable material in the plasticization unit (10) via the closable insertion opening (14) during metering.

### CROSS REFERENCE TO RELATED APPLICATIONS

The present application claims the priority of German Patent Application 10 2008 061 270.7 filed on Dec. 10, 2008, the disclosure content of which is herewith also expressly incorporated into the subject of the present application.

### TECHNICAL FIELD

The invention relates to a device and a method for producing moulded parts from plasticisable material and from fibrous inserts and/or fillers on a cyclically operating injection moulding machine for processing plastics and other plasticisable compositions such as ceramic or powdery compositions.

### BACKGROUND

Such a device and such a method are known from DE 42 36 662 C2 for the production of fibre-reinforced plastic parts. In the device therein fibrous inserts, e.g. of glass, carbon or aramide fibres, are fed directly to the plasticising unit through feed channels and are fed there to the molten plasticised material. The supply occurs through an introduction opening for the fibrous inserts that is arranged in transport direction downstream of the material infeed region for the plasticisable material. A fibre feed connection piece is provided in the region of the introduction opening, so that the fibres can be sheared off by means of the plasticising screw arranged in the plasticising unit. Alternatively, a cutting or separating device, to which the fibre strand can be applied, can be provided in the region of the feed channels for cutting the fibre material to length.

It is known from DE 197 34 834 C2 to feed the fibres to the plastic melt outside the plasticising assembly generating the melt and inject the melt fibre mixture thus formed out of a collecting area into the cavity. The material provided with fibres thus collects upstream of a further plastic melt, which is then injected as core into the area of the fibre-containing material previously injected into the cavity. A comparable solution is known from DE 20 2005 020 728 U1.

A device and a method for injection moulding fibre-reinforced materials is known from DE 199 02 990 C2, in which the corresponding filler and reinforcing substances are firstly added to a plasticised material. The material thus prepared is then fed to a mixer, which in turn injects the material into the injection mould.

The demand for plastics that can be processed with additional fillers is increasing fundamentally. However, the conventional supply of the producers of materials is restricted to the acceptance of large quantities. To be able to produce small quantities and therefore also individual mixtures, it must be possible to process such mixtures directly on the injection moulding machine to thus make individual adjustments.

### BRIEF SUMMARY

The invention provides a device and a method of the aforementioned type in such a manner that a targeted introduction is possible in the cycle of the injection moulding machine.

In this case, the introduction of fibrous inserts and/or fillers occurs directly into the plasticising unit into the molten plastic composition. This introduction occurs specifically during dispensing, i.e. the access to the plasticising unit is not constantly open, but is closable as required. The introduction opening is closed by the device for introducing the fibrous inserts and the fillers itself. In an advantageous configuration, this device can also simultaneously be the cutting or separating device for cutting the fibrous inserts to length.

The device for introducing the fibrous inserts and/or fillers is advantageously operated in a controlled manner, for which purpose a control device is provided that preferably controls the introduction according to volume of the fibrous inserts or fillers in dependence on the dosage of the plasticisable material.

Further advantages are evident from the sub-claims and the following description of a preferred exemplary embodiment.

### BRIEF DESCRIPTION OF THE FIGURES

The invention is explained in more detail below on the basis of an exemplary embodiment shown in the Figures:

FIG. 1 is a three-dimensional view of an injection moulding unit according to the invention;

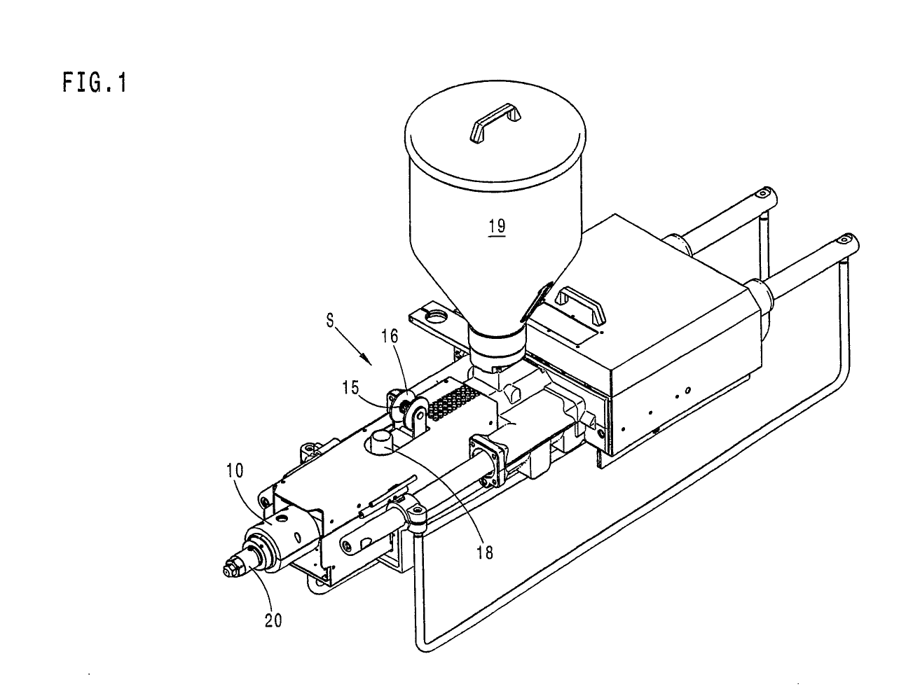

FIG. 2 is a view in longitudinal section through the injection moulding unit of FIG. 1;

FIGS. 3, 4 are enlarged sectional views in the region of the introduction opening for the fibrous inserts and/or fillers with open and closed introduction opening.

### DETAILED DESCRIPTION

The invention is now explained in more detail in an exemplary manner with reference to the attached drawings. However, the exemplary embodiments are only examples that are not intended to restrict the inventive concept to a specific arrangement. Before the invention is described in detail, it should be noted that it is not restricted to the respective structural parts of the device and the respective method steps, since these structural parts and methods can vary. The terms used here are merely intended to describe special embodiments and are not used in a restrictive manner. If, moreover, the singular or indefinite article is used in the description or the claims, this also relates to these elements in the plural unless the overall context clearly indicates otherwise.

The Figures show an injection moulding unit S as component of a plastic injection moulding machine or an injection moulding machine for processing plastics and other plasticisable materials such as ceramic or powdery materials. This injection moulding unit S has a standard structure, i.e. plasticisable material fed to the plasticising unit 10 via the material collection container 19 through a material infeed region 13 is melted in the plasticising unit 10 and injected by means of a plasticising screw 11 into a cavity (not shown in the drawing) of an injection mould, which is disposed in an associated mould closing unit. For this, a cyclical movement of the plasticising screw 11 occurs within the plasticising unit 10, wherein the plasticising screw is rotated and is axially moved by the motor assembly M. The plasticisable material is then injected into the cavity through the nozzle 20.

Fibrous inserts 12 and/or fillers are added to the plastics and other plasticisable materials such as ceramic or powdery materials. The fed material is prepared in the plasticising unit 10, i.e. is melted and dispensed. At least one introduction opening 14 for the fibrous inserts 12 and/or fillers is provided in transport direction of the plasticising screw 11 downstream of the material infeed region 13 on the plasticising unit 10. Above all in the processing of fibrous inserts at least one cutting or separating device 17, which is arranged in front of or in the introduction opening 14 and to which at least one fibre strand 15 can be applied, is provided in the region of the introduction opening 14 to cut the fibre strand to length to form the fibrous inserts 12.

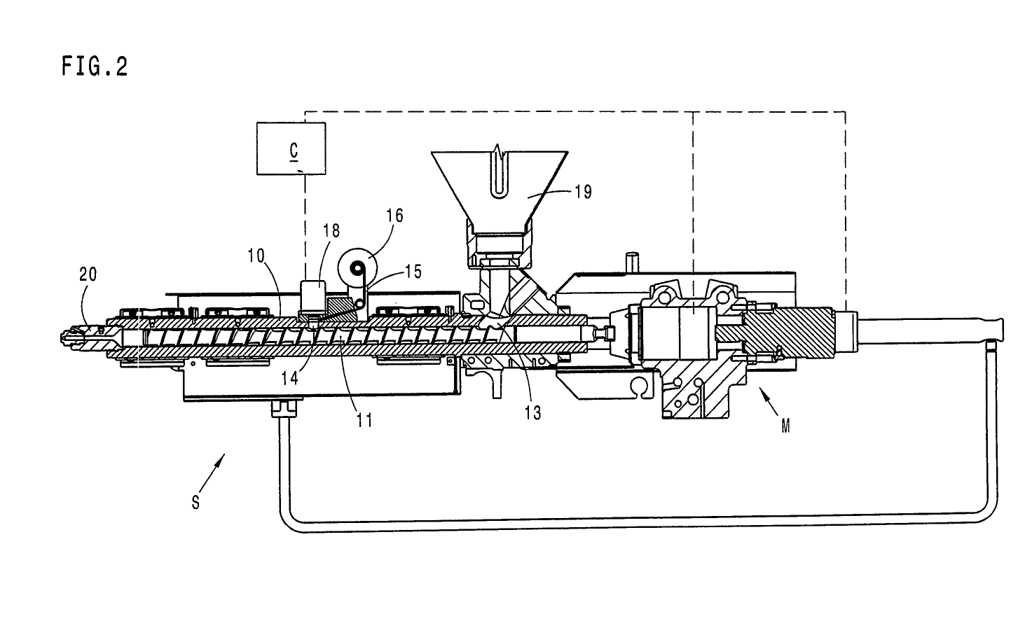

According to FIG. 2 a device 18 operating in the cycle of the injection moulding machine is provided in the region of the introduction opening 14 for introducing the fibrous inserts 12 and/or fillers into the material plasticised in the plasticising unit 10, wherein the introduction opening 14 is closable, so that introduction can occur during dispensing. Thus, on the one hand, a fibre strand 15 can already be cut to length before introduction into the melt of the molten plasticisable material and can be pressed in in a controlled or close loop controlled manner with the plasticising screw 11 stationary. The quantity of fibrous inserts 12 and/or filler or the volume thereof can be added in a controlled and programmable manner in dependence on the quantity of the plasticisable material by a control device C. The quantity of fibrous inserts can also be determined, for example, by a displacement measurement of the fed fibre strand. It is thus possible to insert fibrous inserts and/or fillers directly into the plasticising unit 10 into the molten plastic composition during dispensing in a controlled and programmable manner. Small quantities can therefore also be processed directly at injection moulding machines.

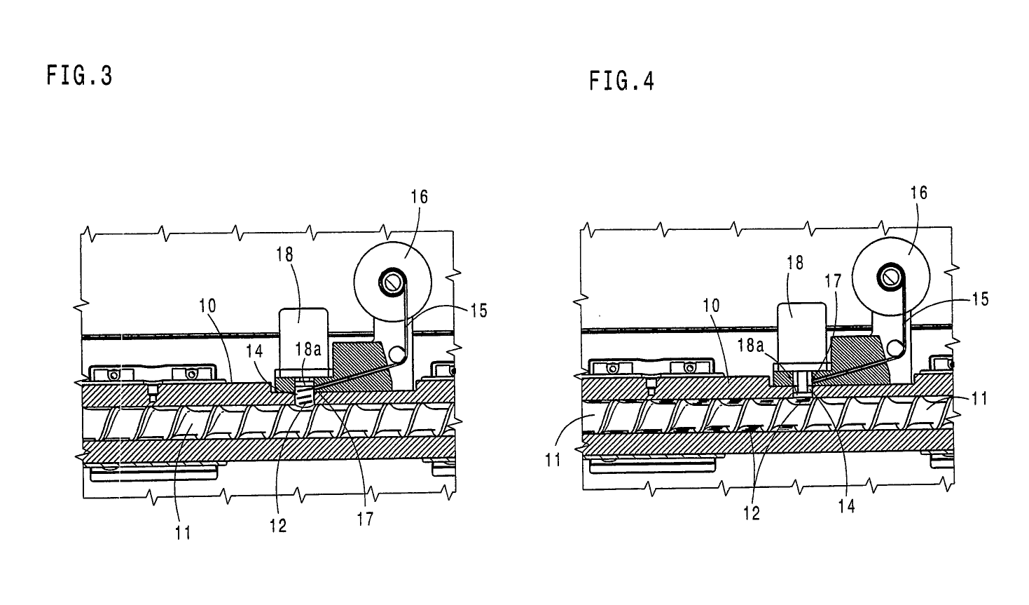

The introduction of long glass fibres as fillers is implemented in the exemplary embodiments. Alternative fillers or even alternative fibres are also usable. The device has an unwinding device 16 for the fibre strand 15 and also a device 18 for introducing the fibrous inserts 12 and/or fillers. This device is formed by a piston-cylinder unit in the exemplary embodiment and is clearly evident in particular in FIGS. 3 and 4. The device 18 for introducing the fibrous inserts 12 and/or fillers can simultaneously be the cutting or separating device 17. In the exemplary embodiment the length of the fibre can be determined in association with the length at the fed fibre strand by means of a cutting edge of the plunger 18a. The fibres are cut by means of the cutting edge of the device 18 for introducing the fibrous inserts 12 or fillers, so that a controllable introduction according to quantity of the cut fibres is possible by a dependence of parameters on screw dispensing path or volume. The dosage is simultaneously dependent on the stroke-dependent movement of the plunger of the piston-cylinder unit.

A control device C is connected to the injection moulding unit S and parts thereof by means of different signal lines. The device 18 for introducing the fibrous inserts 12 and/or the separating and cutting device 17 can be actuated in a controlled and programmable manner by means of the control device C. This allows a controlled and programmable feed of fibrous inserts and fillers.

According to the method the plasticisable material is fed via a material infeed region 13 to the plasticising unit 10 provided with the plasticising screw 11 for plasticising and dispensing the plasticisable material. Fibrous inserts 12 and/or fillers are fed through at least one introduction opening 14 arranged in transport direction of the plasticisable material downstream of the material infeed region 13. The introduction opening is located directly at the plasticising unit 10, so that the fibrous inserts 12 and/or fillers are introduced in the cycle of the injection moulding machine into the molten plasticisable material through the introduction opening 14 during dispensing. The fibrous inserts 12 can be cut to length and introduced into the plasticising unit 10 by the same device, e.g. as is shown in FIGS. 3 and 4 by the plunger 18a and the associated piston-cylinder unit as device 18. The fibrous inserts 12 and/or fillers can be introduced in a controlled and programmed manner, particularly with respect to length and quantity of the fibrous inserts and fillers, by a control device C. Introduction preferably occurs in a volume-dependent manner in dependence on the dosage of the plasticisable material. The introduction opening 14 is closable as required by the device 18 for introduction the fibrous inserts 12. However, the introduction opening can also be closed by other elements, which are preferably also operated in a controlled manner by the control device C.

It is clearly understood that this description can be subject to a wide variety of modifications, amendments and adaptations, which constitute equivalents to the attached claims.

1. Device for producing moulded parts from plasticisable material and from at least one of fibrous inserts or fibrous fillers on a cyclically operating injection moulding machine for processing plastics and other plasticisable materials such as ceramic or powdery materials, comprising
a plasticising unit,
a plasticising screw disposed in the plasticising unit for plasticising and dispensing the plasticisable material,
at least one material infeed region for feeding the plasticisable material to the plasticising unit,
at least one introduction opening for the at least one of the fibrous inserts or the fibrous fillers arranged on the plasticising unit downstream of the material infeed region for the plasticisable material in a transport direction of the plasticising screw,
a device operating in a cycle of the injection moulding machine for introducing the at least one of the fibrous inserts or the fibrous fillers into the material plasticised in the plasticising unit through the at least one introduction opening during dispensing the plasticisable material, wherein the at least one of the fibrous inserts or the fibrous fillers are cut to length before introduction into a melt of the plasticisable material,
wherein the introduction opening is closable by means of the device for introducing the at least one of the fibrous inserts or the fibrous fillers during dispensing the plasticisable material.

2. Device according to claim 1, wherein at least one cutting or separating device, which is arranged in front of or in the introduction opening and to which at least one fibre strand can be applied, is provided to cut the fibre strand to length to form the fibrous inserts.

3. Device according to claim 2, wherein the device for introducing the at least one of the fibrous inserts or the fibrous fillers is at the same time the cutting or separating device.

4. Device according to claim 1, wherein the device for introducing the at least one of the fibrous inserts or the fibrous fillers is a piston-cylinder unit.

5. Device according to claim 1, wherein a control device is provided for the controlled and programmable actuation of the device for introducing the at least one of the fibrous inserts or the fibrous fillers as well as the cutting or separating device.

6. Device according to claim 5, wherein the control device controls the introducing the at least one of the fibrous inserts or the fibrous fillers according to volume of the at least one of the fibrous inserts or fibrous fillers in dependence on a dosage of the plasticisable material.

7. (canceled)

8. Method for producing moulded parts from plasticisable material and from at least one of fibrous inserts or fibrous fillers on a cyclically operating injection moulding machine for processing plastics and other plasticisable materials such as ceramic or powdery materials comprising the steps
feeding a plasticisable material via a material infeed region into a plasticising unit provided with a plasticising screw for plasticising and dispensing the plasticisable material,
feeding the at least one of fibrous inserts or fibrous fillers through at least one introduction opening in a transport direction of the plasticisable material downstream of the material infeed region in a cycle of the injection molding machine during the dispensing the plasticisable material, wherein the at least one of the fibrous inserts or the fibrous fillers are cut to length before introduction into a melt of the molten plasticisable material,
wherein the introduction opening is closable by means of the device for introducing the at least one of the fibrous inserts or the fibrous fillers during dispensing the plasticisable material.

9. Method according to claim 8, wherein a cutting to length of a fibre strand provides the at least one of the fibrous inserts or the fibrous fillers in front of or in the at least one introduction opening arranged in the plasticising unit.

10. Method according to claim 9, wherein the at least one of the fibrous inserts or the fibrous fillers are cut to length and introduced into the plasticising unit by the same device.

11. Method according to claim 8, wherein the at least one of the fibrous inserts or fibrous fillers are introduced in a controlled and programmable manner by a control device.

12. Method according to claim 8, wherein the volume of the at least one of the fibrous inserts or the fibrous fillers is introduced in dependence on a dosage of the plasticisable material.

13. (canceled)

14. Method according to claim 11, wherein the control device controls length and quantity of the at least one of the fibrous inserts or the fibrous fillers.
